(19) United States
(12) Patent Application Publication
(10) Pub. No.: US 2015/0001052 A1
(43) Pub. Date: Jan. 1, 2015

(54) MECHANICAL SWITCH FOR CONTROLLING ELECTRICAL POWER OF ELECTRONIC SENSORS

(71) Applicant: Vijay Nadkarni, San Jose, CA (US)

(72) Inventor: Vijay Nadkarni, San Jose, CA (US)

(73) Assignee: Mobiplex, Inc., San Jose, CA (US)

(21) Appl. No.: 14/299,361

(22) Filed: Jun. 9, 2014

Related U.S. Application Data
(60) Provisional application No. 61/839,920, filed on Jun. 27, 2013.

(51) Int. Cl. H01H 35/14

(52) U.S. Cl. CPC H01H 35/14
USPC 200/61.45 R

(57) ABSTRACT

Methods, systems and apparatus for controllably activating a motion apparatus are disclosed. One apparatus includes a mechanical switch, the mechanical switch including a switch contact, wherein the switch contact is open when the mechanical switch is at rest, and at least momentarily closed when the mechanical switch is subject to at least a threshold level of acceleration. The apparatus further includes a controller, wherein the controller is operative to activate the apparatus upon detecting that the mechanical switch is at least momentarily closed. One method of controllably activating a motion apparatus includes at least momentarily closing a mechanical switch of the motion apparatus when subjecting the motion apparatus to at least a threshold level of acceleration, sensing that the mechanical switch was at least momentarily closed, and activating, by a controller, the motion sensing upon detecting that the mechanical switch is at least momentarily closed.

### RELATED APPLICATIONS

This patent application claims priority to provisional patent application Ser. No. 61/839,920 filed Jun. 27, 2013, which is herein incorporated by reference.

### FIELD OF THE DESCRIBED EMBODIMENTS

The described embodiments relate generally to electronic sensing. More particularly, the described embodiments relate to methods, systems and apparatuses for a mechanical switch that controls electrical power of electronic sensors.

### BACKGROUND

Applications for the field of miniature electronics sensors continually increase. This field touches a wide swath of markets and industries that are as diverse as vehicular telematics, earthquake detection, home & corporate security, senior safety, infant safety, athletic performance, sports improvement, guided missile systems, only to name a few.

One class of wireless sensors that has gained popularity in recent years is motion sensing devices. Such sensors, commonly available as accelerometers, gyroscopes, tilt sensors, shock sensors and magnetometers, have the ability to detect precise levels of acceleration, rotation and spatial orientation in three dimensions, and thereby provide a precise measure of the types of motions that occur in the objects or devices that they are attached to.

As further background, the sensing mechanisms in such devices consist of transducers that are activated by a variety of technologies such as micro-electro-mechanical systems (MEMS), piezoelectric crystals, pressure sensors, force-activated resistors or others.

Battery-operated portable electronic devices all have a common goal of having as long a useful battery life as much as possible. The longer the charge on the battery can last before needing re-charging, the more flexibility and usefulness the device offers to its users.

It is desirable to have an apparatus and method for a mechanical switch controlling electrical power of electronic sensors. Desirably, the mechanical switch initiates power to the electronic sensors only when needed, thereby conserving power.

### SUMMARY

An embodiment includes an apparatus. The apparatus includes a mechanical switch, the mechanical switch including a switch contact, wherein the switch contact is open when the mechanical switch is at rest, and at least momentarily closed when the mechanical switch is subject to at least a threshold level of acceleration. The apparatus further includes a controller, wherein the controller is operative to activate the apparatus upon detecting that the mechanical switch is at least momentarily closed.

Another embodiment includes a method of controllably activating a motion apparatus. The method includes at least momentarily closing a mechanical switch of the motion apparatus when subjecting the motion apparatus to at least a threshold level of acceleration, sensing that the mechanical switch was at least momentarily closed, and activating, by a controller, the motion sensing upon detecting that the mechanical switch is at least momentarily closed.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an athletic movement sensing device attached to a golf club for sensing motion of a golf swing of a user, according to an embodiment.

FIG. 2 shows a block diagram of an athletic motion sensing apparatus, according to an embodiment.

FIG. 3 shows a block diagram of an athletic motion sensing apparatus, according to another embodiment.

FIGS. 4A and 4B show various configurations of switch contacts of mechanical switches, according to an embodiment.

FIG. 5 shows waveforms of motion sensors, according to an embodiment.

FIG. 6 shows waveforms that depict durations of mechanical switch closures that provide an indication of a type of activation event, according to an embodiment.

FIG. 7 is a flow chart that includes steps of a method of controllably activating a motion apparatus, according to an embodiment.

### DETAILED DESCRIPTION

The described embodiments include methods, systems and apparatuses for reducing the consumption of battery power for electronic and electro-mechanical motion sensors. At least some embodiments include motion detection, capture and analysis using electronic sensors, and conservation of power of such sensors and their supporting electronics. For at least some of the described embodiments, motion sensors are put into a sleep mode to conserve power, and are waken up to capture events when the events occur. By doing so, the two objectives of sensing technology are addressed collectively: the ability to capture important events that matter, and extended battery life that allows the sensing devices to be unattended for long periods of time.

The nature of the motion sensing applications involves events that can occur at any time, with no pre-determined temporal pattern. This requires the motion sensors to be in a state where they are ready to be activated within an instant upon the occurrence of an event, and typically without explicit human intervention by way of pushing the “on” button.

However, the very nature of “watching out” for the said event typically requires the electronic circuit to be in an operational state of readiness. However, keeping the circuit in operational readiness creates a finite drain on its battery and runs counter to the goal of reducing its battery life. If the sensors are placed in a sleep or standby mode, with the objective of conserving power, they sensors could very well miss an event that occurs when they are in a standby state. Thus, in common designs, sensors have to be kept active all the time, simply to catch that one all-important event.

For at least some embodiments, a MEMS (Micro-electromechanical systems) accelerometer and a MEMS gyroscope are used for detection of the athletic motion of a human being. More specifically, the accelerometer and gyroscope are attached to a golf club and capture the swing of a golfer.

As the golf club moves through the air, the motion sensors jointly sense the acceleration and rotational parameters in three dimensions. Thereafter, the sensed data is subjected to motion analysis and the path of the golf club is mapped out in three dimensional space, and various characteristics of the golf club's movement are determined, such as the face angle, club speed, lie angle, attack angle, and so on.

However, golfers do not swing the club every few seconds. In fact, there are typically long periods that elapse, sometimes up to several minutes, between consecutive golf swings. In order to maintain the battery consumption low, it is desirable to have the sensor go into sleep mode or better yet turn off completely between swings, and wake up only when the next swing is taking place or just about to take place.

At least some of the described embodiments include recognition of an impending golf swing, and further waking up sensor electronics in time for the sensing electronics to capture the golf swing, yet do so without the electronic circuit having to be in a battery-draining state of operational readiness.

The described embodiments provide a few key features. The motion sensors are kept in a very low-power standby mode or turned off entirely until the event that needs to be captured is about to occur. This results in a major reduction in power consumption, significantly elongating the battery life of the portable unit. When the motion event does occur, a conductive mechanical cantilever or conductive torsion bar serving as an electrical switch moves to close the switch contact, thereby activating the electronic circuit, which then achieves a state of operational readiness instantly allowing the relevant motion capture to occur satisfactorily. The specific nature of the switch closure caused by the motion of the conductive cantilever provides the electronic circuit precise detail on the type of movement that occurred prior to the activation of the electronic circuit.

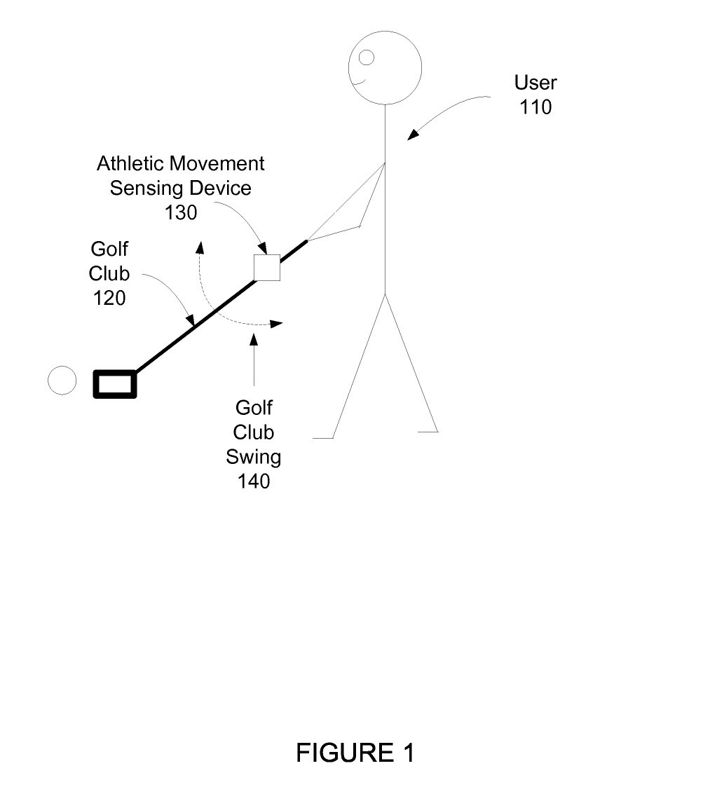

FIG. 1 shows an athletic movement sensing device 130 attached to a golf club 120 for sensing motion of a golf swing of a user 110, according to an embodiment. For an embodiment, the sensing device 130 senses motion parameters (trajectory, acceleration, velocity, rotation, etc.) of the golf club swing 140 of the user 110. As previously described, the sensing electronics (accelerometers, gyroscopes, magnetic sensors, etc.) consume power when operational. At least some of the described embodiments reduce power consumption of the sensing electronics by only powering the sensing electronics when sensing is needed.

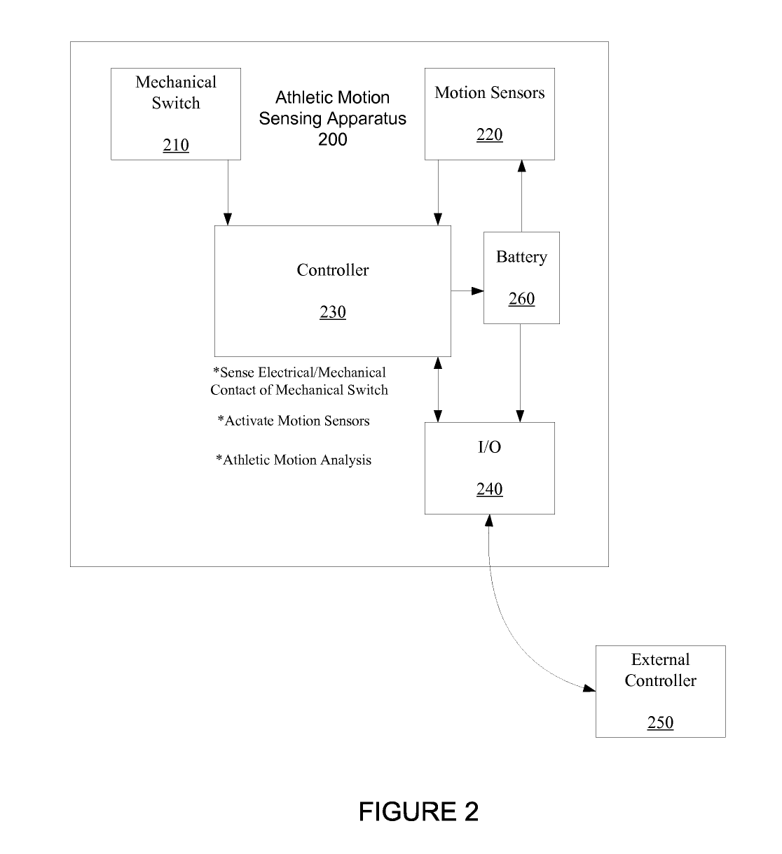

FIG. 2 shows a block diagram of an athletic motion sensing apparatus 200, according to an embodiment. The sensing apparatus 200 includes a mechanical switch 210, a controller 230, and motion sensing electronics 220. At least some embodiments further includes I/O (input/output) electronics that allows the controller 230 to electrically interface with an external controller 250.

For at least some embodiments, the controller 230 is operative to sense electrical and mechanical contact of the mechanical switch 210 due to the sensing apparatus having been subjected to a level of acceleration greater than a minimal threshold amount. For example, motion of a golf club that the sensing apparatus is attached to can cause the mechanical switch 210 to at least momentarily close due to an electrical and mechanical contact of electrical conductors within the mechanical switch 210.

For at least some embodiments, the controller 230 senses when the at least momentary closing of the mechanical switch 210 occurs. When the at least momentary closing of the mechanical switch 210 is sensed, the controller 230 controls the electrical power provided to the motion sensors (sensing electronics) 220. For example, the controller 230 can provide electrical power to the motion sensors 220 and to the I/O electronics as provided by a battery 260.

When a user of the sensing apparatus 200 is attempting to use or activate the sensing apparatus 200, the mechanical switch 210 is tuned to at least momentarily close. That is, the user of the sensing apparatus 200 subjects the sensing apparatus 200 to a level of acceleration that causes the mechanical switch 210 is tuned to at least momentarily close.

As described, the apparatus 200 includes the mechanical switch 210. Further, the mechanical switch 210 includes a switch contact, wherein the switch contact is open when the mechanical switch 210 is at rest, and at least momentarily closed when the mechanical switch 210 is subject to at least a threshold level of acceleration. Further, the controller 230 is operative to activate the apparatus upon detecting that the mechanical switch is at least momentarily closed.

For at least some embodiments, the apparatus 200 includes an athletic movement sensing device.

For at least some embodiments, the mechanical switch includes a conductive mechanical cantilever or a conductive torsion bar, wherein the conductive cantilever or conductive torsion bar deforms when subjected to acceleration. For at least some embodiments, the conductive cantilever or conductive torsion bar deforms enough to at least momentarily mechanically and electrically contact a conductor of the mechanical switch, thereby at least momentarily closing the mechanical switch when subjected to the threshold level of acceleration. For at least some embodiments, the conductive cantilever or conductive torsion bar is mechanically tuned to deform to at least momentarily mechanically and electrically contact the conductor of the mechanical switch based on a type of athletic movement being sensed by the apparatus.

For at least some embodiments, the switch contact includes a mechanical and electrical contact when the switch contact is at least momentarily closed. For at least some embodiments, the controller senses either the mechanical or the electrical contact, and activates the apparatus. For at least some embodiments, the apparatus 200 further includes the motion sensing electronics 220, wherein the controller 230 activates the motion sensing electronics 220 after sensing either the mechanical or the electrical contact.

For at least some embodiments, the controller 230 is further operative to de-activate the apparatus 200 after sensing a lack of motion of the apparatus 200 for at least a threshold period of time. For at least some embodiments, the controller 230 is further operative to de-activate the apparatus 200 after sensing a specific sequence of motion of the apparatus 200. For at least some embodiments, the motion or lack of motion is sensed by the motion sensors 220 of the apparatus 200. For at least some embodiments, the motion or lack of motion is sensed by the mechanical switch 210 of the apparatus 200.

For at least some embodiments, the motion sensing electronics 220 is operative to sense specific athletic movements after the motion sensing electronics 220 is activated. For at least some embodiments, the apparatus 200 is attachable to a golf club, and the motion sensing electronics 220 is operative to sense a swing of the golf club.

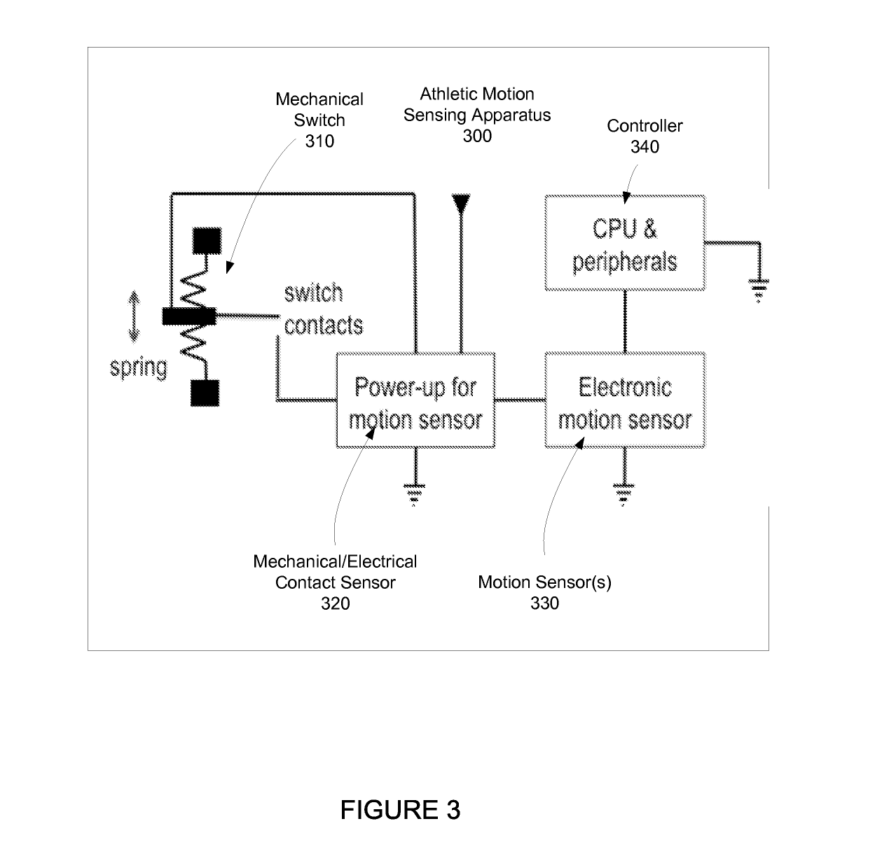

FIG. 3 shows a block diagram of an athletic motion sensing apparatus 300, according to another embodiment. This embodiment includes the mechanical switch 310 which is shown as including a spring-mechanism, wherein switch contacts of the mechanical switch 310 at least momentarily make mechanical and electrical contact when the apparatus 300 and the mechanical switch 310 are subject to acceleration great enough that the spring-mechanism allows the switch contacts to mechanically and electrically contact.

A mechanical/electrical contact sensor 320 senses when the switch contacts make contact. This can be accomplished, for example, by sensing the completion of an electrical circuit which causes current to flow through the switch contacts and the electrical circuit. Motion sensors 330 of the apparatus 300 are activated upon sensing the mechanical and electrical contact of the switch contacts. Further, a controller 340 (CPU and peripherals) is activated.

The mechanical switch 310 is open when the sensing apparatus 300 is at rest. The mechanical switch 310 only closes at least momentarily when the mechanical switch is subject to a level of acceleration large enough to cause the switch contact to close. The level of acceleration required to cause the switch contact to close can be adjusted or selected based on the mechanical structure of the mechanical switch 310.

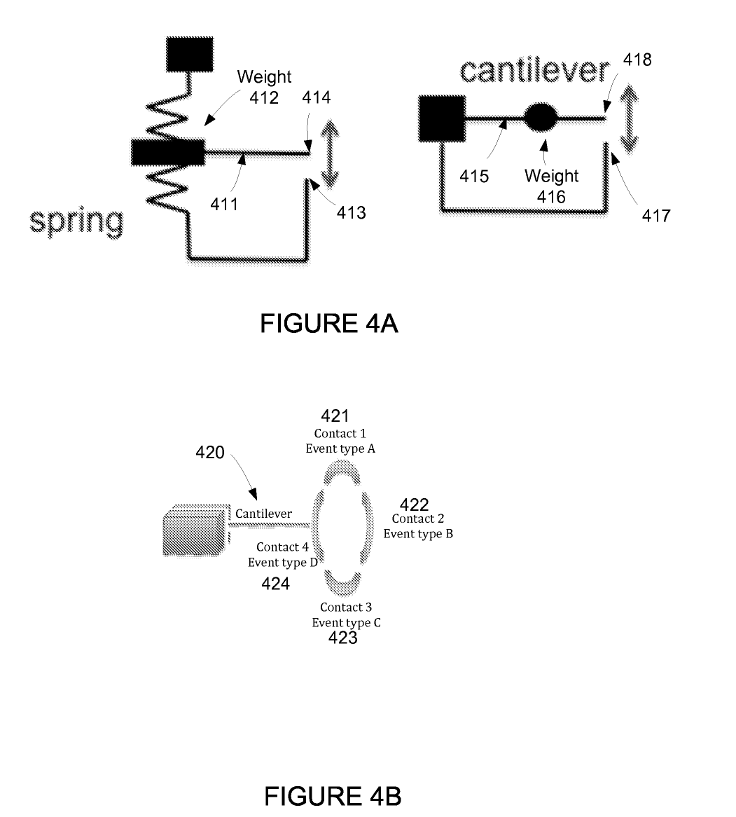

FIGS. 4A and 4B show various configurations of switch contacts of mechanical switches, according to an embodiment. FIG. 4A shows a spring-mechanism mechanical switch wherein a spring and an extending conductive arm 411 with weighting mass 412 are deformed when subject to acceleration. When subject to enough acceleration, the conductive arm 411 makes contact with a conductive contact 413, thereby at least momentarily making a mechanical and electrical contact between conductive contacts 413, 414. The acceleration can by in the form of vibrations, angular motion or any other form of movement of the mechanical switch.

FIG. 4A also shows a cantilever-mechanism mechanical switch that includes a conductive arm 415 that includes weighting mass 416. Again, when subject to enough acceleration, the conductive arm 415 makes contact with a conductive contact 417, thereby at least momentarily making a mechanical and electrical contact between conductive contacts 417, 418.

In the inoperative state, the electronic circuits of the apparatus are either completely off, or in a very low power standby mode, where its power consumption is zero or negligible. The electronic circuits of the apparatus possesses the intelligence to enter the inoperative state following the absence of events for some time duration, or upon the detection of some motion pattern that indicates the temporary cessation of events that need to be captured.

Since the mechanical switch is motion actuated, it is possible for the various types of motion that cause switch closure to provide further detail on the nature of the event. This can be done in one of two ways—(a) position of the switch contact, and (b) duration of the switch contact.

FIG. 4B shows a cantilever mechanical switch, wherein an extended conductive arm 420 and weight provide for mechanical and electrical contact when subjected to acceleration greater than a threshold. As shown, the mechanical switch includes a plurality of switch contacts 421, 422, 423, 424.

For this embodiment, the contact position of the switch closure can provide a good indication of the type of event that caused activation of the electronic circuit. The sensor can move in a variety of ways, and it is possible for the switch contact to be deflected in various directions depending on the type of motion. For example, a linear force along the Y-axis of the sensor might cause the switch to have closure with Contact 1 421 (denoting Event type A) and a linear acceleration in the opposite Y-axis direction might cause the switch to have closure with Contact 4 423 (denoting Event type C); whereas a linear acceleration along the X-axis might cause the switch to have closure with Contact 2 422 (denoting Event type B), and a linear acceleration in the opposite X-axis direction might cause the switch to have closure with Contact 4 424 (denoting Event type D). Thereafter, when the circuit is active, the nature of the switch closure that occurred before its activation can provide the circuit with a good knowledge of the type of event that occurred, and how to properly respond to it.

As previously described, the mechanical switch of FIG. 4B includes multiple switch contacts. For an embodiment, the multiple contacts can be used to detect different types of motion, and further, provide a mechanical identification of the type of motion. Linear motion of the mechanical switch may cause at least some of the multiple switch contracts to contact or close, and angular motion may cause other of the multiple switch contacts to contact or close. For at least some embodiments, the closure of the switch contacts provides an identification of the nature and direction of the motion. For example, a sequence of contacts (for example, switch contact closure of contact 1 to switch contact closure of contact 2 to switch contact closure of contact 3) can be used to identify type or nature of motion. For example, linear in downward vertical may contact at a contact 1, whereas a linear upward motion may contact at a contact 3. Further, an identifiable sequence of switch contacts can be used to indicate a type of motion. This all occurs with minimal conduction of current. For at least some embodiments, detection of certain sequences of switch contacts can be used to initiate a wake up and motion sensing.

For at least some embodiments, the mechanical switch further comprises a plurality of switch contacts, wherein the plurality of switch contacts are open when the mechanical switch is at rest, and at least one of the plurality of switch contacts at least momentarily closes when the mechanical switch is subject to at least a threshold level of acceleration. For at least some embodiments, as described, different combinations of one or more of the plurality of switch contacts at least momentarily close when the mechanical switch is subject to different orientations of acceleration of at least a threshold level of acceleration. For at least some embodiments, a controller of the sensing apparatus is operative to identify one or more characteristic categories of motion based on a sensed sequence of closures of one or more of the plurality of switch contacts. Examples of characteristics of categories of motion include, for example, backswing, top of swing, downswing and follow through of a golf swing.

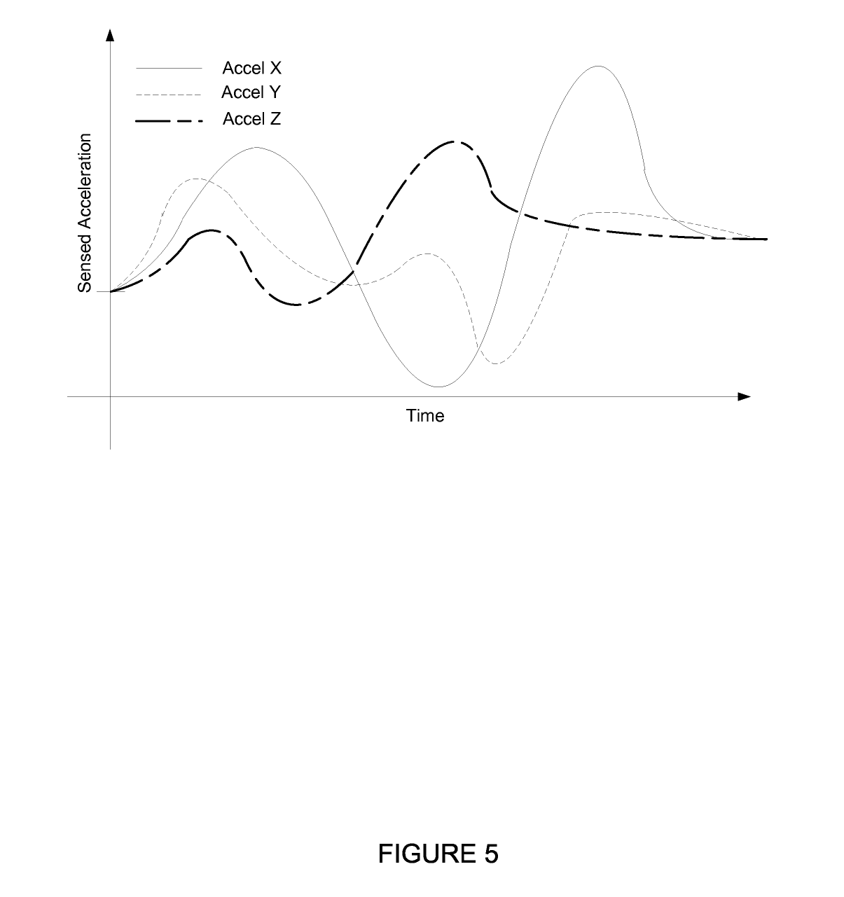

FIG. 5 shows waveforms of motion sensors, according to an embodiment. FIG. 5 shows exemplary waveforms of accelerometers of the sensing apparatus, as it captures the data from, for example, a golf swing. Each axis (X, Y, Z) senses its own sensed motions. For example, and one of the sensed axis shows the centrifugal force encountered by the accelerometer as the club traverses its swing path. This centrifugal force, upon reaching sufficient magnitude, can cause a conductive cantilever to deflect and close electrically the switch. The switch closure, serves to trigger the wakeup of the electronic circuit, which then proceeds to activate the motion sensors and capture the data.

It is to be noted that the centrifugal force is part of the swing itself, and a concern may be that the triggering of the switch contact after the initiation of the golf swing may, result in the loss of most of the swing occurring prior to the peak centrifugal force. In reality, for the specific use case of golf (and indeed for most other sports and athletic activities), there is a practice motion that precedes the actual athletic motion (for golf, it is a practice swing). It is actually the practice swing that activates the turning on of the electronic circuit. Thereafter, the actual swing, which typically occurs within a few seconds of the practice swing, is captured perfectly by the sensors.

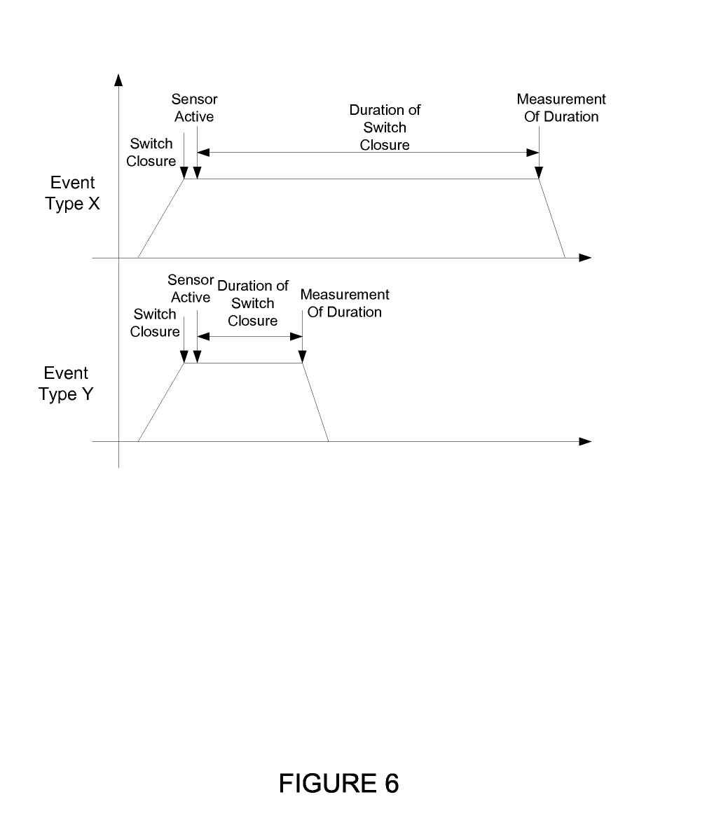

FIG. 6 shows waveforms that depict durations of mechanical switch closures that provide an indication of a type of activation event, according to an embodiment. For example, a sharp momentary jolt would cause a switch closure with a very small duration, whereas a low centrifugal force in a golf swing might cause a switch closure with medium duration, and a high centrifugal force in a golf swing might cause a switch closure with higher duration. Each of these provides its own insight into the nature of the movement. For example, upon detecting a momentary jolt, the electronic circuit might elect to reject the motion altogether, upon detecting a medium duration closure, the circuit might assess that the golfer took a low-speed practice swing, whereas for a higher duration the circuit might infer a higher speed swing.

As shown in FIG. 6, a first event (event type X) results in a duration of switch contact closure of a first duration of time, and a second event (event type Y) results in a duration of switch contact closure of a second duration of time. As described, the sensed durations of contact can additionally or alternatively be used to identify a type of motion.

For an embodiment, a controller of the sensing apparatus is operative sense time durations of closures of the different combinations of one or more of the plurality of switch contacts. For at least some embodiments, the controller is further operative to identify one or more characteristic categories of motion based on the sensed time durations of the closures of the different combinations of one or more of the plurality of switch contacts.

Once the circuitry of the sensing apparatus has been activated, it proceeds to perform its operational functions of capturing the motions of the sensors of the sensing apparatus, and using them to analyze the athletic performance of the sportsperson. At some time thereafter, the athletic activities will cease or will encounter a period of inactivity. The electronic circuit possesses the intelligence, based on the nature of the athletic activity that it is analyzing, to recognize the indicators for deactivation of the sensors and conservation of battery power by turning itself off or going into low power mode, where power consumption is zero or negligible.

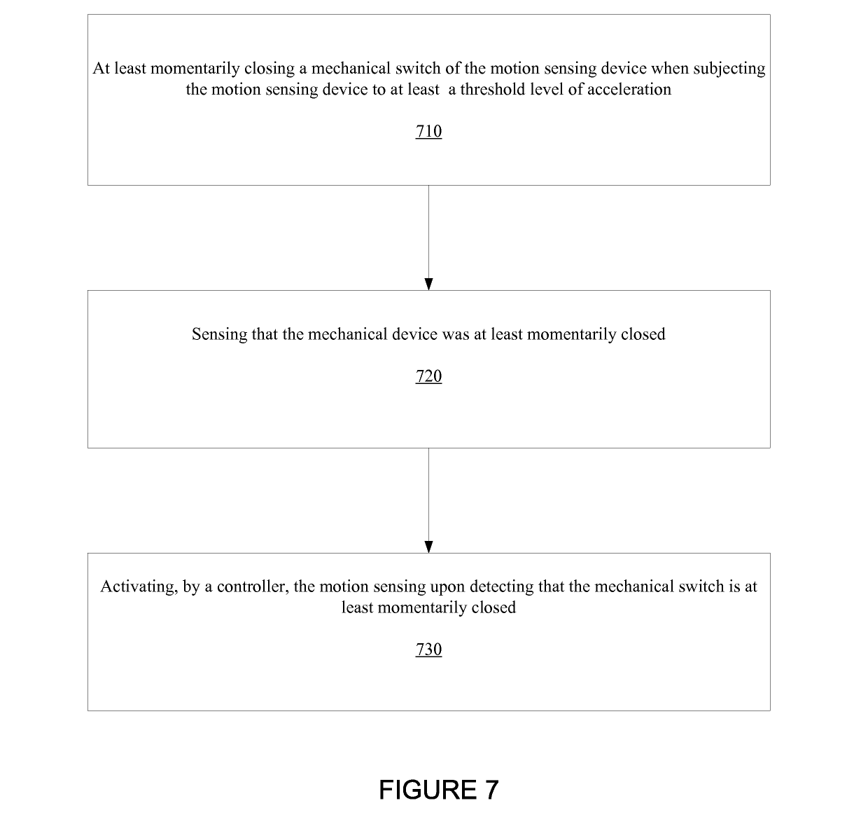

FIG. 7 is a flow chart that includes steps of a method of controllably activating a motion apparatus, according to an embodiment. A first step 710 includes at least momentarily closing a mechanical switch of the motion apparatus when subjecting the motion apparatus to at least a threshold level of acceleration. A second step 720 includes sensing that the mechanical switch was at least momentarily closed. A third step 730 includes activating, by a controller, the motion sensing upon detecting that the mechanical switch is at least momentarily closed.

For at least some embodiments, the mechanical switch further includes a plurality of switch contacts, wherein the plurality of switch contacts are open when the mechanical switch is at rest, and at least one of the plurality of switch contacts at least momentarily closes when the mechanical switch is subject to at least a threshold level of acceleration. For at least some embodiments, different combinations of one or more of the plurality of switch contacts at least momentarily close when the mechanical switch is subject to different orientations of acceleration of at least a threshold level of acceleration. At least some embodiments further include identifying one or more characteristic categories of motion based on a sensed sequence of closures of one or more of the plurality of switch contacts. At least some embodiments further include sensing time durations of closures of the different combinations of one or more of the plurality of switch contacts. At least some embodiments further include identifying one or more characteristic categories of motion based on the sensed time durations of the closures of the different combinations of one or more of the plurality of switch contacts.

For at least some embodiments, each of the plurality of switch contacts completes or closes an electrical circuit, thereby causing current to flow through the corresponding circuit. The controller is operable to sense the conducted current. Further, for at least some embodiments the controller is operable to sense time durations of the current flowing through the corresponding circuit.

As previously described, for an embodiment, the mechanical switch includes a conductive mechanical cantilever or a conductive torsion bar, wherein the conductive cantilever or conductive torsion bar deforms when subjected to acceleration. As previously described, for an embodiment, the conductive cantilever or conductive torsion bar deforms enough to at least momentarily mechanically and electrically contact a conductor of the mechanical switch, thereby at least momentarily closing the mechanical switch when subjected to the threshold level of acceleration. As previously described, for an embodiment, the conductive cantilever or conductive torsion bar is mechanically tuned to deform to at least momentarily mechanically and electrically contact the conductor of the mechanical switch based on a type of athletic movement being sensed by the apparatus.

As previously described, for an embodiment, the switch contact includes a mechanical and electrical contact when the switch contact is at least momentarily closed. As previously described, an embodiment includes sensing either the mechanical or the electrical contact, and activating the apparatus. As previously described, an embodiment includes activating motion sensing electronics after sensing either the mechanical or the electrical contact. As previously described, for an embodiment, the motion sensing electronics is operative to sense specific athletic movements after the motion sensing electronics is activated.

Although specific embodiments have been described and illustrated, the embodiments are not to be limited to the specific forms or arrangements of parts so described and illustrated.

What is claimed:

1. An apparatus comprising:
a mechanical switch, the mechanical switch comprising a switch contact, wherein the switch contact is open when the mechanical switch is at rest, and at least momentarily closed when the mechanical switch is subject to at least a threshold level of acceleration; and
a controller, wherein the controller is operative to activate the apparatus upon detecting that the mechanical switch is at least momentarily closed.

2. The apparatus of claim 1, wherein the mechanical switch further comprises a plurality of switch contacts, wherein the plurality of switch contacts are open when the mechanical switch is at rest, and at least one of the plurality of switch contacts at least momentarily closes when the mechanical switch is subject to at least a threshold level of acceleration.

3. The apparatus of claim 2, wherein different combinations of one or more of the plurality of switch contacts at least momentarily close when the mechanical switch is subject to different orientations of acceleration of at least a threshold level of acceleration.

4. The apparatus of claim 3, wherein the controller is further operative to identify one or more characteristic categories of motion based on a sensed sequence of closures of one or more of the plurality of switch contacts.

5. The apparatus of claim 3, wherein the controller is further operative sense time durations of closures of the different combinations of one or more of the plurality of switch contacts.

6. The apparatus of claim 5, wherein the controller is further operative to identify one or more characteristic categories of motion based on the sensed time durations of the closures of the different combinations of one or more of the plurality of switch contacts.

7. The apparatus of claim 1, wherein the mechanical switch comprises a conductive mechanical cantilever or a conductive torsion bar, wherein the conductive cantilever or conductive torsion bar deforms when subjected to acceleration.

8. The apparatus of claim 7, wherein the conductive cantilever or conductive torsion bar deforms enough to at least momentarily mechanically and electrically contact a conductor of the mechanical switch, thereby at least momentarily closing the mechanical switch when subjected to the threshold level of acceleration.

9. The apparatus of claim 7, wherein the conductive cantilever or conductive torsion bar is mechanically tuned to deform to at least momentarily mechanically and electrically contact the conductor of the mechanical switch based on a type of athletic movement being sensed by the apparatus.

10. The apparatus of claim 1, wherein the switch contact includes a mechanical and electrical contact when the switch contact is at least momentarily closed.

11. The apparatus of claim 10, wherein the controller sensing either the mechanical or the electrical contact, and activates the apparatus.

12. The apparatus of claim 11, further comprising motion sensing electronics, wherein the controller activates the motion sensing electronics after sensing either the mechanical or the electrical contact.

13. The apparatus of claim 12, wherein the controller is further operative to de-activate the apparatus after sensing a lack of motion of the apparatus for at least a threshold period of time.

14. The apparatus of claim 12, wherein the controller is further operative to de-activate the apparatus after sensing a specific sequence of motion of the apparatus.

15. The apparatus of claim 12, wherein the motion sensing electronics is operative to sense specific athletic movements after the motion sensing electronics is activated.

16. The apparatus of claim 15, wherein the apparatus is attachable to a golf club, and the motion sensing electronics is operative to sense a swing of the golf club.

17. A method of controllably activating a motion apparatus, comprising:
at least momentarily closing a mechanical switch of the motion apparatus when subjecting the motion apparatus to at least a threshold level of acceleration;
sensing that the mechanical switch was at least momentarily closed; and
activating, by a controller, the motion sensing upon detecting that the mechanical switch is at least momentarily closed.

18. The method of claim 17, wherein the mechanical switch further comprises a plurality of switch contacts, wherein the plurality of switch contacts are open when the mechanical switch is at rest, and at least one of the plurality of switch contacts at least momentarily closes when the mechanical switch is subject to at least a threshold level of acceleration.

19. The method of claim 18, wherein different combinations of one or more of the plurality of switch contacts at least momentarily close when the mechanical switch is subject to different orientations of acceleration of at least a threshold level of acceleration.

20. The method of claim 19, further comprising identifying one or more characteristic categories of motion based on a sensed sequence of closures of one or more of the plurality of switch contacts.

21. The method of claim 20, further comprising sensing time durations of closures of the different combinations of one or more of the plurality of switch contacts.

22. The method of claim 21, further comprising identifying one or more characteristic categories of motion based on the sensed time durations of the closures of the different combinations of one or more of the plurality of switch contacts.
